(19) United States
(12) Patent Application Publication
(10) Pub. No.: US 2018/0147856 A1
(43) Pub. Date: May 31, 2018

(54) INKJET RECORDING APPARATUS

(71) Applicant: Roland DG Corporation, Hamamatsu-shi (JP)

(72) Inventors: Takayuki Sekiguchi, Hamamatsu-shi (JP); Kenji Kawagoe, Hamamatsu-shi (JP)

(21) Appl. No.: 15/820,546

(22) Filed: Nov. 22, 2017

(30) Foreign Application Priority Data
Nov. 28, 2016 (JP) 2016-230259

(51) Int. Cl. B41J 2/20; B41J 2/145; B41J 2/175

(52) U.S. Cl. CPC B41J 2/20; B41J 2/175; B41J 2/145

(57) ABSTRACT

A printer includes an ink channel including an upstream end connectable with a cartridge storing ink, a downstream end connected to the ink head, and a middle section located between the upstream end and the downstream end. The printer also includes an air inlet tube provided in the middle section and permitting air to be introduced into the ink channel.

### CROSS REFERENCE TO RELATED APPLICATIONS

This application claims the benefit of priority to Japanese Patent Application No. 2016-230259 filed on Nov. 28, 2016. The entire contents of this application are hereby incorporated herein by reference.

### BACKGROUND OF THE INVENTION

### 1. Field of the Invention

The present invention relates to inkjet recording apparatuses.

### 2. Description of the Related Art

Inkjet recording apparatuses (hereinafter referred to as “inkjet printers”) are well known, which perform predetermined printing operations on a recording medium by an inkjet technique. An inkjet printer is furnished with a supply channel for ink (hereinafter referred to as “ink channel”) that connects a cartridge storing ink with an ink head incorporating a plurality of nozzles ejecting ink.

In the inkjet printer, a cleaning solution may be introduced into the ink channel when an ink to be ejected from the ink head needs to be changed to another type of ink or when the ink channel is clogged (see, for example, JP 2016-104522 A). Thereby, the interior of the ink channel is cleaned. As a result, for example, it is possible to prevent the occurrence of color mixing resulting from mixing of different color inks when an ink is changed to another ink, and it is also possible to resolve faulty ink ejection.

When cleaning the ink channel, it is necessary to use an appropriate cleaning solution depending on the type of ink used by the inkjet printer. For example, when an aqueous ink is used, it is necessary to use an aqueous cleaning solution. On the other hand, when a solvent ink (such as an ink in which a pigment is dispersed in an organic solvent) is used, it is necessary to use a solvent cleaning solution. There is a tendency that it takes a long time to connect a cartridge storing a cleaning solution to an ink channel and introduce the cleaning solution into the ink channel to clean the entire ink channel. Moreover, because cleaning solutions are relatively expensive, cleaning the ink channel with a large amount of cleaning solution leads to an increase in cost.

### SUMMARY OF THE INVENTION

In view of the foregoing and other problems, preferred embodiments of the present invention provide inkjet printers that reduce the amount of cleaning solution necessary and clean the ink channels more quickly.

An inkjet recording apparatus according to a preferred embodiment of the present invention includes: an ink head including a nozzle surface provided with a plurality of nozzles to eject ink; an ink channel including an upstream end connectable with a cartridge storing ink, a downstream end connected to the ink head, and a middle section located between the upstream end and the downstream end; and an air inlet provided in the middle section and permitting air to be introduced into the ink channel.

In an inkjet recording apparatus according to a preferred embodiment of the present invention, the ink inlet, which permits air to be introduced into the ink channel from outside the ink channel, is provided in the middle section of the ink channel. By introducing the air into the ink channel, impurities in the ink channel are removed, and the ink channel is cleaned. Because air is introduced from the middle section, the air is circulated through the entire ink channel more quickly than in cases where air is introduced from the upstream end or a downstream portion of the ink channel (for example, from the nozzles provided in the ink head). As a result, it is possible to clean the ink channel more quickly.

Various preferred embodiments of the present invention make it possible to provide inkjet printers that reduce the amount of cleaning solution used and clean ink channels more quickly.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view illustrating a printer according to a preferred embodiment of the present invention.

FIG. 2 is a front view illustrating a main portion of a printer according to a preferred embodiment of the present invention.

FIG. 3 is a block diagram illustrating a structure that supplies ink from an ink cartridge to an ink head in a printer according to a preferred embodiment of the present invention.

FIG. 4 is a side view illustrating a damper according to a preferred embodiment of the present invention.

FIG. 5 is a cross-sectional view taken along line V-V in FIG. 4.

FIG. 6 is a block diagram illustrating a structure that introduces air into an ink supply channel according to a preferred embodiment of the present invention.

### DETAILED DESCRIPTION OF THE PREFERRED EMBODIMENTS

Hereinbelow, inkjet recording apparatuses according to preferred embodiments of the present invention will be described with reference to the drawings. An inkjet recording apparatus according to the present preferred embodiment is an inkjet printer (hereinafter simply “printer”) 10 that prints on a recording medium. The preferred embodiments described herein are, of course, not intended to limit the present invention. The features and components that exhibit the same effects are denoted by the same reference symbols, and repetitive description thereof may be omitted as appropriate.

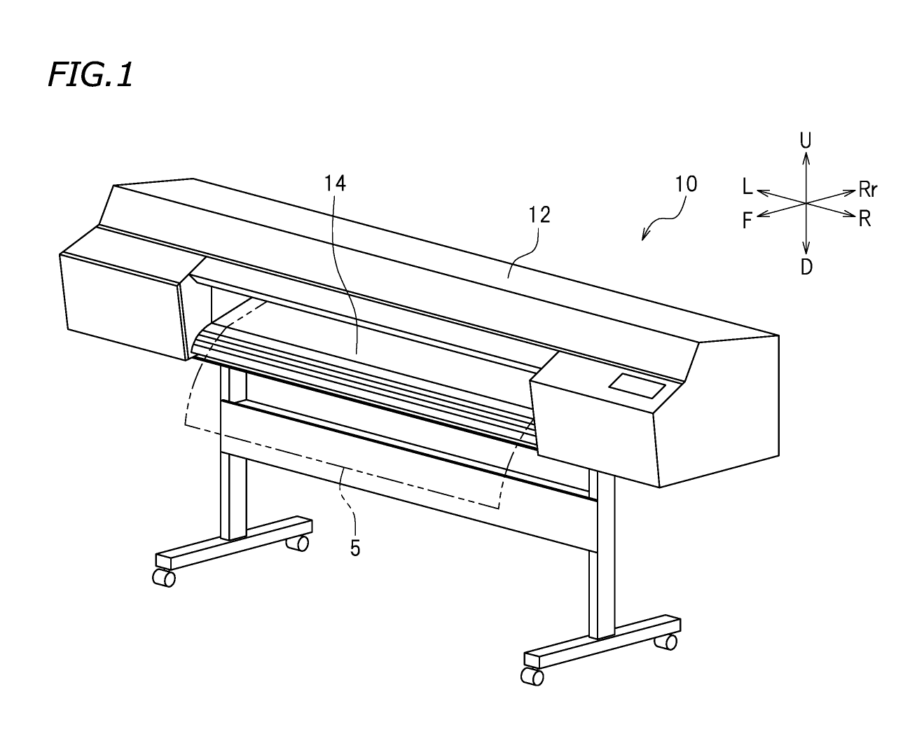

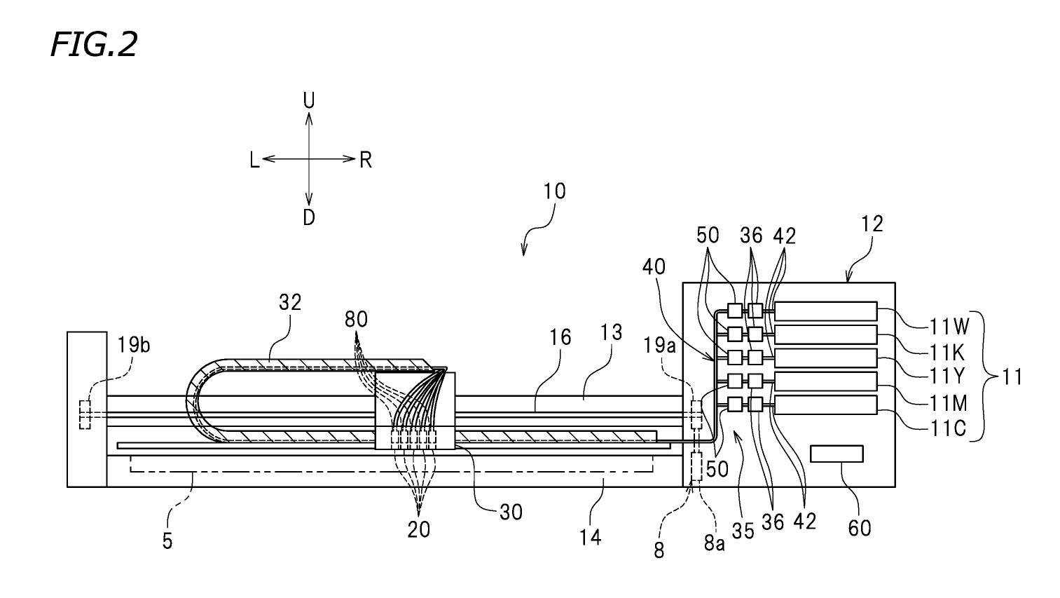

FIG. 1 is a perspective view illustrating the printer 10 according to the present preferred embodiment. FIG. 2 is a front view illustrating a main portion of the printer 10 according to the present preferred embodiment. The printer 10 prints on a recording medium 5. The recording medium 5 may include a variety of recording media, including of course paper materials such as plain paper, and any media made of various materials including resin materials such as polyvinyl chloride (PVC) and polyesters, aluminum, iron, and wood.

In the following description, the terms “left,” “right,” “up,” and “down” respectively refer to left, right, up, and down as defined based on the perspective of the operator facing the printer 10. A direction toward the operator relative to the printer 10 is defined as “frontward,” and a direction away from the operator relative to the printer 10 is defined as “rearward.” Reference characters F, Rr, L, R, U, and D in the drawings represent front, rear, left, right, up, and down, respectively. A later-described ink head 20 (see FIG. 2) is capable of moving leftward and rightward. The recording medium 5 is capable of being transferred frontward and rearward. These directional terms are, however, merely provided for convenience in description, and are not intended to limit in any way the manner in which the printer 10 should be arranged.

As illustrated in FIG. 1, the printer 10 includes a main body 12, and a platen 14 provided in the main body 12. The recording medium 5 is placed on the platen 14.

As illustrated in FIG. 2, the printer 10 includes a guide rail 13 provided in the main body 12. The guide rail 13 extends along a leftward/rightward direction. A carriage 30 is fitted to the guide rail 13. The carriage 30 is caused to reciprocate by a carriage moving mechanism 8 in leftward and rightward directions along the guide rail 13. The carriage moving mechanism 8 includes a pulley 19b and a pulley 19a disposed respectively at the left end and the right end of the guide rail 13. The pulley 19a is connected a carriage motor 8a. It is possible, however, that the carriage motor 8a may be connected to the pulley 19b. The pulley 19a is driven by the carriage motor 8a. An endless belt 16 is wrapped around the pulleys 19a and 19b. The carriage 30 is secured to the belt 16. As the pulleys 19a and 19b rotate to run the belt 16, the carriage 30 moves in a leftward or rightward direction. Thus, the carriage 30 is movable in leftward and rightward directions along the guide rail 13.

The platen 14 is provided with a grit roller (not shown) and pinch rollers (not shown), which are arranged vertically and paired with each other. The grit roller is connected to a feed motor (not shown). The grit roller is driven to rotate by the feed motor. By rotating the grit roller with the recording medium (see FIG. 1) pinched between the grit roller and the pinch rollers, the recording medium 5 is delivered in a frontward or rearward direction (i.e., a sub-scanning direction).

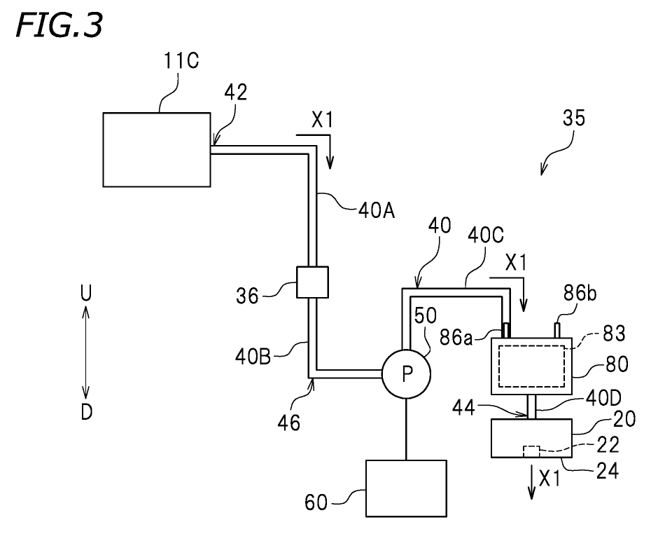

As illustrated in FIG. 2, the main body 12 includes a plurality of ink cartridges 11. Each of the ink cartridges 11 is a tank that stores ink. Specifically, a plurality of ink cartridges 11C, 11M, 11Y, 11K, and 11W are mounted detachably to the main body 12. More specifically, each of the ink cartridges 11C, 11M, 11Y, 11K, and 11W is detachably connected to an upstream end 42 (see FIG. 3) of an ink channel 40, which will be described later. The ink cartridge 11C stores cyan ink. The ink cartridge 11M stores magenta ink. The ink cartridge 11Y stores yellow ink. The ink cartridge 11K stores black ink. The ink cartridge 11W stores white ink. It should be noted that the inks to be stored in the ink cartridges 11 are not limited to the just-mentioned examples.

As illustrated in FIG. 2, the printer 10 includes a plurality of ink supply systems 35 provided for respective ink cartridges 11 storing various colors of ink. Each of the ink supply systems 35 includes, in addition to the ink cartridge 11, an ink head 20, a damper 80, an ink channel 40, a feed pump 50, and a pressure control valve 36. The feed pump 50 is an example of a fluid delivery device. The ink head 20 and the damper 80 are mounted on the carriage 30 so that they reciprocate in leftward and rightward directions. On the other hand, the ink cartridges 11 are not mounted on the carriage 30, so they do not reciprocate in leftward and rightward directions. For that reason, a large portion (at least half the overall length) of the ink channel 40 is arranged so as to extend along the leftward/rightward direction so that the ink channel 40 does not break when the carriage 30 moves in leftward and rightward directions. Because five types of inks are preferably used in the present preferred embodiment, for example, five ink channels 40 are provided in total. Each of the ink channels 40 is covered with a cable protection and guide device 32.

As an example, the following describes an ink supply system 35 that includes an ink cartridge 11C storing cyan ink, an ink head 20, a damper 80, an ink channel 40, a feed pump 50, and a pressure control valve 36. It should be noted that the same configuration is also preferably used for each of the ink supply systems 35 including the ink cartridges 11M, 11Y, 11K, and 11W. FIG. 3 is a block diagram illustrating the structure that supplies ink from the ink cartridge 11C to the ink head 20. In FIG. 3, the direction in which ink flows when printing is indicated by arrow X1.

As illustrated in FIG. 3, the ink head 20 includes a plurality of nozzles 22 that eject ink onto the recording medium 5 (see FIG. 2) and a nozzle surface 24 in which the nozzles 22 are provided. The nozzle surface 24 is exposed outwardly from the bottom surface of the carriage 30 (see FIG. 2). Among a plurality of nozzles 22, only one of the nozzles 22 is depicted in FIG. 3.

As illustrated in FIG. 3, the ink cartridge 11C and the ink head 20 are allowed to communicate with each other via the ink channel 40. The ink channel 40 forms a flow channel that directs ink from the ink cartridge 11C to the damper 80 and the ink head 20. The ink channel 40 may be soft and flexible, and it is preferably elastically deformable. The configuration of the ink channel 40 is not limited to a particular configuration. However, in the present preferred embodiment, the ink channel 40 is a tube that is easily deformable and made of resin. It should be noted, however, that the ink channel 40 may be defined by of a material or structure other than a tube. A portion of the ink channel 40 may be defined by a tube. The ink channel 40 includes an upstream end 42 that is connectable with an ink outlet of the ink cartridge 11C, a downstream end 44 that is connected to the ink head 20, and a middle section 46 that is located between the upstream end 42 and the downstream end 44.

As illustrated in FIG. 3, the ink channel 40 includes a tube 40A, a tube 40B, a tube 40C, and a tube 40D. The tube 40A allows the ink cartridge 11C and the pressure control valve 36 to communicate with each other. The tube 40B allows the pressure control valve 36 and the feed pump 50 to communicate with each other. The tube 40C allows the feed pump 50 and the damper 80 to communicate with each other. The tube 40D allows the damper 80 and the ink head 20 to communicate with each other. The upstream end 42 is provided in the tube 40A. The downstream end 44 is provided in the tube 40D. The middle section 46 is a section of the tubes 40A to 40D that is located between the upstream end 42 and the downstream end 44.

As illustrated in FIG. 3, the feed pump 50 is provided in the middle section 46 of the ink channel 40. The feed pump 50 is provided between the pressure control valve 36 and the damper 80. The feed pump 50 delivers a fluid (such as ink and air) in the ink channel 40. The feed pump 50 is able to supply (feed) ink from the ink cartridge 11C to the ink head 20. The feed pump 50 is able to send air from the ink head 20 to the upstream end 42. The feed pump 50 of the present preferred embodiment may be, but is not limited to, a tube pump. By using a tube pump, it is possible to reduce the number of parts required and simplify the configuration. When air is introduced from a later-described air inlet tube 86b into the ink channel 40, the feed pump 50 is operated and brought into an open condition.

As illustrated in FIG. 3, the pressure control valve 36 is disposed in the middle section 46 of the ink channel 40. The pressure control valve 36 is provided between the ink cartridge 11C and the feed pump 50. The pressure control valve 36 controls the pressure of the nozzles 22 of the ink head 20 to a negative pressure to prevent ink leakage when the power of the printer 10 is turned off. The pressure control valve 36 closes the ink channel 40 when the power of the printer 10 is turned off. The pressure control valve 36 opens the ink channel 40 when the feed pump 50 is operating.

As illustrated in FIG. 3, the damper 80 is in communication with the ink head 20 and supplies ink to the ink head 20. The damper 80 also alleviates ink pressure fluctuations. The damper 80 stabilizes the ink ejection operation of the ink head 20. The damper 80 is provided in the middle section 46 of the ink channel 40. The damper 80 is provided between the feed pump 50 and the ink head 20. The damper 80 includes a reservoir chamber 83 that temporarily stores the ink supplied from the ink cartridge 11C.

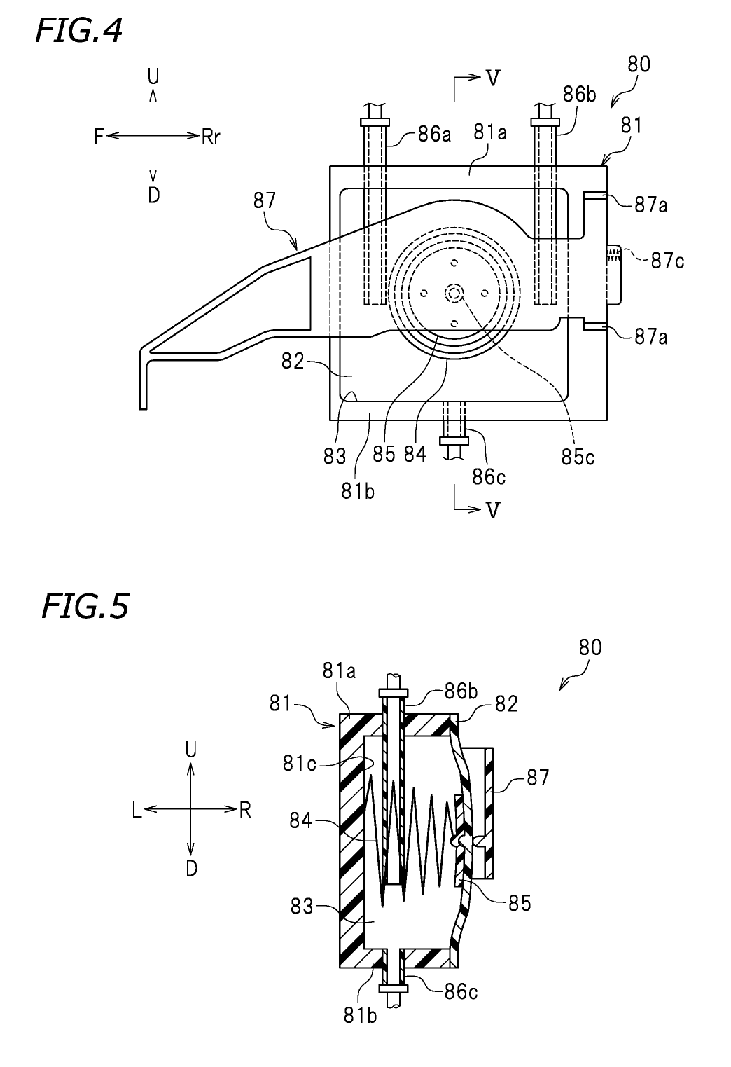

FIG. 4 is a side view illustrating the damper according to the present preferred embodiment of the present invention. FIG. 5 is a vertical cross-sectional view of the damper 80 taken along line V-V in FIG. 4. As illustrated in FIG. 5, the damper 80 includes a case main body 81 having a hollow structure with an opening provided in one surface (the right side surface in FIG. 5) thereof, and a damper membrane 82 fitted to an outer wall surface of the case main body 81 so as to cover the opening. The case main body 81 is typically made of resin. The region surrounded by the case main body 81 and the damper membrane 82 is the reservoir chamber 83. A lever 87 is disposed on the surface of the damper membrane 82 opposite the reservoir chamber 83. Note that the damper 80 of the present preferred embodiment does not have a so-called valve structure.

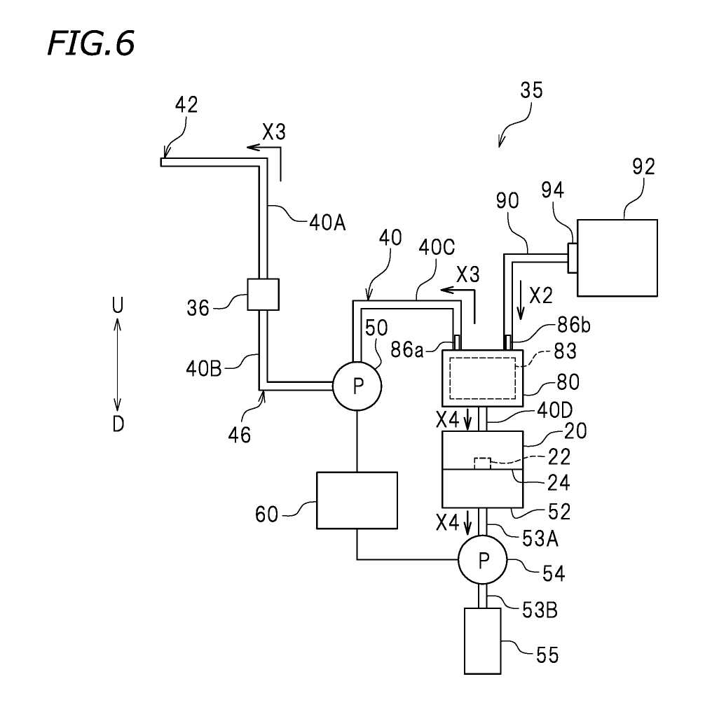

As illustrated in FIG. 4, provided in an upper wall 81a of the case main body 81 are an ink inlet tube 86a into which ink flows, and an air inlet tube 86b that permits air to be introduced from outside the damper 80 into the ink channel 40. The air inlet tube 86b is an example of the air inlet. The ink inlet tube 86a is connected to the tube 40C (see FIG. 3) and is in communication with the ink cartridge 11C. As illustrated in FIG. 6, the air inlet tube 86b is connectable with a later-described compressor 92 via a tube 90. The air inlet tube 86b is configured to withstand air having a dew-point temperature of, for example, about −60° C. to about −10° C. (preferably from about −50° C. to about −20° C., for example about −40° C.). The air inlet tube 86b is configured to withstand air having a pressure of, for example, about 80 kPa to about 100 kPa. Note that the air inlet tube 86b is sealed by a cap (not shown) when the air is not introduced from outside the damper 80 (from the compressor 92 herein), typically when printing. The lower end of the air inlet tube 86b is located downward relative to the ink inlet tube 86a. The air inlet tube 86b is located rearward relative to the ink inlet tube 86a. Provided in a lower wall 81b of the case main body 81 is an ink outlet tube 86c through which ink flows out. The ink outlet tube 86c is connected to the tube 40C (see FIG. 3) and is in communication with the ink head 20 (see FIG. 3). Each of the ink inlet tube 86a, the air inlet tube 86b, and the ink outlet tube 86c is in communication with the reservoir chamber 83. The reservoir chamber 83 temporarily stores a predetermined amount of ink supplied from the ink cartridge 11C.

As illustrated in FIG. 5, the damper membrane 82 is affixed to an edge portion of the case main body 81 by, for example, thermal welding, with a tensile force such as to be able to bend inwardly and outwardly of the reservoir chamber 83. The damper membrane 82 is an example of pressure sensitive membrane, and it is able to undergo flexural deformation according to the pressure inside the reservoir chamber 83. The damper membrane 82 is typically a flexible resin film.

As illustrated in FIG. 5, the damper 80 includes a tapered spring 84 and a pressure receiver plate 85. One end of the tapered spring 84 is attached to a side wall 81c of the case main body 81 that is opposite the damper membrane 82 in the interior space of the reservoir chamber 83. The other end of the tapered spring 84 is connected to the pressure receiver plate 85. The tapered spring 84 is an example of an elastic member pressing the damper membrane 82 outward of the reservoir chamber 83 via the pressure receiver plate 85. The tapered spring 84 is kept in a compressed state. This keeps the damper membrane 82 in a state in which the damper membrane 82 is pressed and bent outward of the reservoir chamber 83 (rightward in FIG. 5). When the amount of the ink stored in the reservoir chamber 83 decreases to a predetermined amount and the pressure inside the reservoir chamber 83 reduces to a certain pressure, the damper membrane 82 bends inward of the reservoir chamber 83 against the spring force (elastic force) of the tapered spring 84. In the reservoir chamber 83, the pressure receiver plate 85 is disposed between the damper membrane 82 and the tapered spring 84. The pressure receiver plate 85 is disposed at or substantially at the center of the damper membrane 82.

At a time other than printing, in other words, when ink is not ejected from the ink head 20, the reservoir chamber 83 stores ink in a predetermined amount or more. At that time, the damper membrane 82 is bent outward of the reservoir chamber 83 due to the spring force of the tapered spring 84. This keeps the interior of the reservoir chamber 83 at a negative pressure and maintains the nozzle surface 24 of the ink head 20 that is in communication with the reservoir chamber 83 also at a negative pressure. This prevents ink from leaking from the nozzles 22 of the ink head 20.

As illustrated in FIG. 5, the lever 87 is disposed outside the reservoir chamber 83. The lever 87 is an ink reserve amount detection device that detects the amount of stored ink from a degree of bending (position change) of the damper membrane 82. As illustrated in FIG. 4, the lever 87 is secured to a wall surface of the case main body 81 by two fasteners 87a, for example. The lever 87 is contactable with the center 85c of the pressure receiver plate 85 through the damper membrane 82. The lever 87 moves toward and away from the damper membrane 82 via a spring member 87c, and is in contact with the damper membrane 82 at all times. The lever 87 changes its position according to the flexural deformation of the damper membrane 82.

For example, when the amount of the ink stored in the reservoir chamber 83 decreases, the damper membrane 82 bends inward of the reservoir chamber 83 in a predetermined amount. In association with the flexural deformation of the damper membrane 82, the lever 87 changes its position in a direction approaching the reservoir chamber 83 in a predetermined amount. On the other hand, when ink is supplied to the reservoir chamber 83 and the amount of the ink therein increases, the damper membrane 82 bends outward of the reservoir chamber 83 in a predetermined amount. In association with the flexural deformation of the damper membrane 82, the lever 87 changes its position in a direction away from the reservoir chamber 83 in a predetermined amount. In this way, based on the information of position change of the lever 87, it is possible to determine whether or not the amount of the ink stored in the reservoir chamber 83 is within a predetermined range. For example, it is possible to determine whether the amount of the ink stored in the reservoir chamber 83 has reached a predetermined lower limit value, and/or whether the amount of the ink stored has reached a predetermined upper limit value (i.e., whether the reservoir chamber 83 is filled up).

As illustrated in FIG. 6, the ink supply system 35 includes a cap 52, a first suction tube 53A, a suction pump 54, a second suction tube 53B, and a waste ink tank 55. The cap 52 is detachably fitted onto the ink head 20 so as to cover the nozzles provided in the nozzle surface 24 at the time other than printing. The first suction tube 53A is connected to the cap 52 and the suction pump 54. The second suction tube 53B is connected to the suction pump 54 and the waste ink tank 55. When the cap 52 is fitted to the ink head 20, a sealed space is provided between the cap 52 and the nozzle surface 24. This prevents the ink adhering to the ink head 20 from drying and prevents the nozzles 22 from clogging. The suction pump 54 sucks out the fluid (such as air or ink) and solid matter (solidified ink, dust, or the like) that is present in the sealed space. When the suction pump 54 is actuated with the cap 52 fitted on the ink head 20, the fluid inside the sealed space is sucked out. For example, if the printer is not used for a long period of time, the nozzles 22 may be clogged by dried and solidified ink. The above-described structure removes such dried and solidified ink in a desirable manner. This makes it possible to carry out stable printing. When air is introduced through the air inlet tube 86b into the ink channel 40, the suction pump 54 is in an operated and open condition. The ink sucked out of the nozzles 22 is collected in the waste ink tank 55.

As illustrated in FIG. 6, the present preferred embodiment uses the compressor 92 when introducing the air into the ink channel 40. The compressor 92 supplies compressed air to the air inlet tube 86b. The compressor 92 is provided with a dryer unit 94. The dryer unit 94 is a device that removes water from the air compressed by the compressor 92 with the use of, for example, an adsorbent agent. The air dehumidified by the dryer unit 94 has, for example, a dew-point temperature of from about −60° C. to about −10° C. (preferably from about −50° C. to about −20° C., for example about −40° C.). The air having a dew-point temperature of about −10° C. or lower, for example, is able to clean the ink channel 40 more desirably. Herein, the term “dew-point temperature” means a dew-point temperature measured at about 80 kPa, for example. More specifically, the term “dew-point temperature” means a dew-point temperature measured at about 80 kPa at room temperature (for example, at about 25° C.), for example. In addition, the air supplied from the compressor 92 has, for example, a pressure of from about 80 kPa to about 100 kPa.

As illustrated in FIG. 2, the printer 10 includes a controller 60. The overall operations of the printer are controlled by the controller 60. The controller 60 may be a computer, for example, and may include a central processing unit (hereinafter also referred to as “CPU”), a ROM that stores programs or the like that are to be executed by the CPU, and a RAM. The controller 60 is connected to the carriage motor 8a, the ink head 20, the pressure control valve 36, the feed pump 50, and the suction pump 54. The controller 60 controls starting, stopping and operation of these elements.

Hereinbelow, the method of cleaning the ink channel 40 is described in detail. As illustrated in FIG. 6, when cleaning the ink channel 40, the ink cartridge 11C is removed from the upstream end 42 of the ink channel 40. The compressor 92 is connected to the air inlet tube 86b via the tube 90. The feed pump 50 is actuated and opened. The pressure control valve 36 is opened. The cap 52 is fitted onto the ink head 20, and the suction pump 54 is actuated and opened.

Next, the compressor 92 is actuated to introduce air through the air inlet tube 86b into the reservoir chamber 83 of the damper 80, as indicated by arrow X2 in FIG. 6. When the air is introduced into the reservoir chamber 83, a portion of the ink that has remained in the reservoir chamber 83 is passed through the tube 40C, the feed pump 50, the tube 40B, the pressure control valve 36, and the tube 40A, and is discharged from the upstream end 42 of the ink channel 40 along with the introduced air, as indicated by arrow X3 in FIG. 6. On the other hand, another portion of the ink that has remained in the reservoir chamber 83 is passed through the tube 40D and the nozzles 22, and is discharged to the cap 52, as indicated by arrow X4 in FIG. 6. The ink discharged to the cap 52 is collected in the waste ink tank 55. Thus, by introducing air from the compressor 92 through the air inlet tube 86b into the reservoir chamber 83, the air is introduced into the ink channel 40, and the introduced air is discharged out of the ink channel 40 from the upstream end 42 of the ink channel 40 and from the nozzles 22. The interior of the ink channel 40, the ink head 20, and so forth are cleaned by the air flowing therethrough.

Herein, when the air dehumidified by the dryer unit 94 is circulated through the ink channel 40 and discharged therefrom, the dew-point temperature of the air discharged from the ink channel 40 (typically the air discharged from the upstream end 42 of the ink channel 40 and the air discharged from the nozzles 22) is, for example, from about −40° C. to about −0° C. (preferably from about −20° C. to about −5° C., for example about −10° C.). When the dew-point temperature of the air discharged from the upstream end 42 of the ink channel 40 reaches a predetermined dew-point temperature (for example, about −10° C.) and also the dew-point temperature of the air discharged from the nozzles 22 does not reach the predetermined dew-point temperature (for example, about −10° C.) the controller 60 controls the feed pump 50 so as to stop and close the feed pump 50. On the other hand, when the dew-point temperature of the air discharged from the upstream end 42 of the ink channel 40 does not reach a predetermined dew-point temperature (for example, about −10° C.) and also the dew-point temperature of the air discharged from the nozzles 22 reaches the predetermined dew-point temperature (for example, about −10° C.), the controller 60 controls the suction pump 54 so as to stop the suction pump 54. In this way, it is possible to clean the inside of the ink channel 40 more efficiently. It should be noted that cleaning of the ink channel 40 and so forth by introducing air from the air inlet tube 86b is not limited to being carried out when the ink to be used in printing is changed, but it may also be carried out when the printer 10 is used for the first time.

As described above, the printer 10 according to a preferred embodiment of the present invention includes the air inlet tube 86b, provided in the middle section 46 of the ink channel 40, that permits air to be introduced from outside the ink channel 40 into the ink channel 40. By introducing the air into the ink channel 40, impurities inside the ink channel 40 are removed, and the ink channel 40 is cleaned. Because the air is introduced from the middle section 46, the air is circulated throughout the ink channel 40 more quickly than in cases where the air is introduced from the upstream end 42 or a downstream portion of the ink channel 40 (for example, the nozzles 22 provided in the ink head 20). As a result, it is possible to clean the ink channel 40 more quickly.

In the printer 10 of the present preferred embodiment, the air inlet tube 86b may be configured to withstand air having a dew-point temperature of from about −60° C. to about −10° C., for example. This enables the air inlet tube 86b to introduce dry air into the ink channel 40 therethrough. Because dry air has excellent cleaning capability for the interior of the ink channel 40, it is possible to clean the ink channel 40 more desirably.

In the printer 10 of the present preferred embodiment, the air inlet tube 86b may be configured to withstand air having a pressure of from about 80 kPa to about 100 kPa, for example. This enables air to be introduced more quickly into the ink channel 40 through the air inlet tube 86b. As a result, it is possible to complete cleaning of the interior of the ink channel 40 more quickly.

The printer 10 of the present preferred embodiment may include the damper 80 provided in the middle section 46 and communicating with the ink head 20. The air inlet tube 86b is provided in the damper 80 and is allowed to communicate with the reservoir chamber 83. Providing the air inlet tube 86b in the damper 80 in this way makes it possible to introduce air into the ink channel 40 easily. Moreover, providing the air inlet tube 86b in the damper 80 makes it possible to introduce the air into the ink channel 40 more quickly.

In the printer 10 of the present preferred embodiment, the controller 60 may stop the feed pump 50 when the dew-point temperature of the air discharged from the upstream end 42 of the ink channel 40 reaches a predetermined dew-point temperature (for example, about −10° C.) so that the air introduced into the ink channel 40 will not be discharged from the upstream end 42. Thereby, the air introduced into the ink channel 40 is discharged from the nozzles 22. As a result, the portion of the ink channel 40 that is connected to the nozzles 22 is cleaned more efficiently. Alternatively, the controller 60 may stop the suction pump 54 when the dew-point temperature of the air discharged from the nozzles reaches a predetermined dew-point temperature (for example, about −10° C.) so that the air introduced into the ink channel 40 will not be discharged from the nozzles 22. Consequently, the air introduced into the ink channel 40 is discharged from upstream end 42. As a result, the portion of the ink channel 40 that is connected to the upstream end 42 is cleaned more efficiently.

Hereinabove, preferred embodiments of the present invention have been described. It should be noted, however, that the foregoing preferred embodiments are merely exemplary and the present invention may be embodied in various other forms.

In the foregoing preferred embodiments, the air inlet tube 86b is preferably provided in the damper 80, but this is merely illustrative. The air inlet tube 86b should be provided at any portion in the middle section 46 of the ink channel 40. For example, the air inlet tube 86b may be provided in the pressure control valve 36. By providing the air inlet tube 86b in the pressure control valve 36 in this way, it is possible to introduce the air into the ink channel 40 easily. Moreover, by providing the air inlet tube 86b in the pressure control valve 36, it is possible to introduce the air into the ink channel 40 more quickly. It is also possible that any of the tubes 40A to 40D may be provided with the air inlet tube 86b.

In the foregoing preferred embodiments, the damper 80 and the ink head 20 are allowed to communicate with each other by the tube 40D, but this example is merely illustrative. The damper 80 and the ink head 20 may be directly connected to each other. In that case, the downstream end 44 of the ink channel 40 is a boundary portion of the damper 80 between the ink head 20 and the damper 80.

In the foregoing preferred embodiments, the air inlet tube 86b is preferably sealed by a cap when air is not introduced therein from the compressor 92. However, it is possible that the air inlet tube 86b may be used for the purpose of circulating the ink within the ink channel 40 therethrough. For example, a three-way valve may be used as the pressure control valve 36, and the air inlet tube 86b may be connected to the three-way valve via the tube 90. Thus, it is possible to provide an ink circulation channel through which the ink within the ink channel 40 is circulated.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An inkjet recording apparatus comprising:
an ink head including a nozzle surface provided with a plurality of nozzles to eject ink;
an ink channel including an upstream end connectable with a cartridge storing ink, a downstream end connected to the ink head, and a middle section located between the upstream end and the downstream end; and
an air inlet provided in the middle section and permitting air to be introduced into the ink channel.

2. The inkjet recording apparatus according to claim 1, wherein the air inlet is configured to withstand air having a dew-point temperature of from about −60° C. to about −10° C.

3. The inkjet recording apparatus according to claim 1, wherein the air inlet is configured to withstand air having a pressure of from about 80 kPa to about 100 kPa.

4. The inkjet recording apparatus according to claim 1, further comprising:
a damper, provided in the middle section, including a reservoir chamber storing the ink at least temporarily, and communicating with the ink head; wherein
the air inlet is provided in the damper and is able to communicate with the reservoir chamber.

5. The inkjet recording apparatus according to claim 1, further comprising:
a fluid delivery device, provided in the middle section, that delivers a fluid in the ink channel;
a cap, detachably attached to the ink head so as to cover the nozzle surface, and defining a sealed space between the cap and the nozzle surface when attached to the ink head;
a suction pump to suck fluid from inside the sealed space; and
a controller configured or programmed to control the fluid delivery device and the suction pump; wherein
the controller is configured or programmed to stop the fluid delivery device when a dew-point temperature of air discharged from the upstream end reaches a predetermined dew-point temperature and to stop the suction pump when a dew-point temperature of air discharged from the nozzles reaches the predetermined temperature.

6. The inkjet recording apparatus according to claim 1, further comprising:
a fluid delivery device, provided in the middle section, that delivers a fluid in the ink channel; and
a pressure control valve provided in the middle section to close the ink channel when power is turned off and to open the ink channel when the fluid delivery device is operating; wherein
the air inlet is provided in the pressure control valve.

7. The inkjet recording apparatus according to claim 6, further comprising:
a cap, detachably attached to the ink head so as to cover the nozzle surface, and defining a sealed space between the cap and the nozzle surface when attached to the ink head;
a suction pump to suck fluid from inside the sealed space; and
a controller configured or programmed to control the pressure control valve and the suction pump; wherein
the controller is configured or programmed to close the ink channel by controlling the pressure control valve when a dew-point temperature of air discharged from the upstream end reaches a predetermined dew-point temperature and to stop the suction pump when a dew-point temperature of air discharged from the nozzles reaches the predetermined dew-point temperature.
